(19) United States
(12) Patent Application Publication
(10) Pub. No.: US 2015/0204489 A1
(43) Pub. Date: Jul. 23, 2015

(54) ELECTRONIC MOULDING TRIM

(71) Applicant: Orlando Baello, Kenmore, WA (US)

(72) Inventor: Orlando Baello, Kenmore, WA (US)

(21) Appl. No.: 14/465,071

(22) Filed: Aug. 21, 2014

Related U.S. Application Data
(60) Provisional application No. 61/929,503, filed on Jan. 21, 2014.

(51) Int. Cl. F21K 99/00; F21V 23/06; F21V 23/00; F21S 8/00; F21V 31/00

(52) U.S. Cl. CPC F21K 9/30; F21K 9/50; F21S 8/00; F21V 31/00; F21V 23/008; F21V 23/06; F21K 9/90; F21Y 2101/02

(57) ABSTRACT

A permanent installation of electronic moulding trim system device and method comprising a plurality of hidden multicolored LED lights or color changing LEDs (light emitting diodes), inside that flashes, fades, chases, dimmable and steady lightings when turned on, controlled via a wireless remote. The device can be attached with a mounting brackets to eaves, fascia, gutters, around windows and doors or any exterior/Interior surface, the power source to the electronic moulding trim may be hardwired or pulls directly to a power outlet. When the device is turned off, the illumination of lights are opaque and looks like a regular moulding trim until the lighting is turned on, then the illuminated lights is visible through translucent moulding trim material.

### CROSS-REFERENCE TO RELATED APPLICATIONS

This application claims the benefit of U.S. Provisional Application No. 61/929,503, filed Jan. 21, 2014, the disclosure of which is herein incorporated by reference.

### FIELD OF INVENTION

The present invention relates to a permanent decorative electronic moulding trim installation with integrated hidden multicolored LED lights or color changing LEDs (light emitting diodes) that flashes, fades, chases, dimmable and steady lightings controlled wirelessly via a remote control device.

### FEDERALLY SPONSORED RESEARCH

N/A

### SEQUENCE LISTING OR PROGRAM

N/A

### BACKGROUND

Typical holiday seasons brings the traditional perennial labor inconvenience and time consuming task of locating, untangling and installing and removing holiday lights strings along the eaves, fascia, gutters and around windows and doors, this also usually involved the danger of injuries and accident, such as falling from ladder, roof, scaffolding and other related dangerous method of installation of holiday lightings.

Furthermore damage to the exterior surface materials from repeated insertion and removal of fasteners and hardware such as staples, hooks, nails, screws, and damages to the light string itself and when stored between holidays. The undesirable job of removing the lighting temp one to forego the task and left the expose lights to the elements all year long, which lead to further damage to the structure and deterioration damage to the lights itself and resulting to unattractive appearance which defeat the purpose of making the house looks good in the first place and also sometimes give a wrong impression of a lazy, procrastinating property owner.

### PRIOR ART

The following relevant art has dealt with overcoming problems such as bulb enclosures with removable cover, flip open door, swingable, and removable screen cover through permanent installation.

Known prior art, such as U.S. Pat. No. 8,599,104 issued to Gardner on Dec. 3, 2013, teaches a modular, flexible panels for mounting lighting strands. In certain embodiments, each individual panel is an integral unit comprised of cables and node holders that combine to create a flexible, scalable and modular lighting surface. One or more of the panel edges can connect to an edge of another panel (either directly or indirectly) to tile multiple panels together to form a modular multi-panel assembly. Each panel provides a surface to which strands of LEDs can be mounted, such as in a uniform pattern. The panel design allows for easy replacement and serviceability of individual lighting strands, and ensures that all of the LEDs face in the same direction. The resulting robust and flexible system can provide full-motion video, graphics and messaging in a transparent single or multi-panel design. However, there is no permanent installation of decorative moulding trim with integrated changing color light bulbs to display holiday lights.

Another prior art, U.S. Pat. No. 8,251, 542 issued to Camerano on Aug. 28, 2012 teaches a light system includes a housing configured to resemble any seasonal or other desired image, i.e., a star, a pumpkin, an Easter egg, a firecracker, etc. The housing includes a rear face, a front face and a peripheral frame with a light-refracting chamber formed there between. The peripheral frame includes a plurality of tricolor LED's mounted therein. The rear face of the housing includes a completely-reflective front surface that deflects 100% of all impacting light beams inwardly toward the front face. However, the rear surface of the front face is only partially-reflective so that only a portion of impacting light is reflected back toward the rear face; a remaining portion of impacting light exits the front face and is visible to those nearby. Accordingly, the light generated by the limited number of LED's will create an illusion that an infinite number of light beams are emanating from the housing. However, there is no permanent installation of decorative moulding trim that blends in with the exterior or interior housing decor with integrated changing color light bulbs to display holiday lights.

U.S. Pat. No. 5,813,751 issued to Shaffer on Sep. 29, 1998 teaches a device for permanent installation of exterior Christmas lighting. The device includes an elongated channel having top and bottom walls joined by a rear wall, and a front wall that depends from the top wall, and a flexible, rectangular screen cover for insertion and retention between the front wall and the bottom wall. The device, in conjunction with one or more additional devices, can be custom fit and mounted by fasteners to a building exterior, such as along principal architectural features—e.g., attached to the eaves or outlining a pitched roof. With the cover screen removed, a string of decorative Christmas lights can be positioned within and stretched from one end of the channel to an opposite end thereof, electrically connected to similar strings within additional such devices, and connected to a source of electrical power. With the devices so mounted and cover screens in place, they visually blend in with a building exterior and are hardly noticeable until the lighting is turned on, and then the illuminated decorative Christmas lighting is easily viewable through holes in the screens. However, there is no permanent installation of decorative moulding trim with integrated changing color light bulbs to display holiday lights.

U.S. Pat. No. 5,404,279 issued to Wood on Apr. 4, 1995 teaches a permanent lighting trim assembly featuring linearly interconnected trim members having a hollow body containing lights and an operable reflective cover member which permits the lights to be displayed at the appropriate season. The lights are protected during the remainder of the year when the cover panel is closed and the lights are hidden. The assembly includes standard length elongated trim members, corner members for extending a trim line around a corner, an adjustable trim member and a multiply adjustable trim member which may also contain lights which are hidden beneath an openable cover member. Each of the components has interconnected plug members at the ends which are notched to form a half-lap for a lap joint which facilitates electrical interconnection of the components along the trim line of the house. An unobtrusive lap joint is formed between components which have body configurations which match each other so that the assembled trim members look a unified structure along the trim line. However, there is no permanent installation of decorative moulding with an integrated changing color light bulbs to display holiday lights, and also still requires to manually flip open the device to exposed the lights which usually involved the danger of injuries and accident, such as falling from ladder, roof, scaffolding and other related dangerous method on trying to reach the device.

Still, a need for a simple and practical permanent solution that is attractive and requires no labor after installation is still desired. The present Invention for an electronic moulding trim system and method is first of its kind and no prior art related will solve all these problems.

### BRIEF SUMMARY OF THE INVENTION

The invention is a permanent decorative electronic moulding trim installation device with integrated hidden multicolored LED lights or color changing LEDs (light emitting diodes) that flashes, fades, chases, dimmable and steady lightings controlled wirelessly via remote control. The device can be attached with mounting brackets to eaves, fascia, gutters, around windows and doors or any exterior/Interior surface and connected to an electrical power.

When the device is turned off, the illumination of lights are obscured and the electronic moulding trim blends in with the building that looks like a regular moulding trim until the lighting is turned on, then the illuminated lights become visible through the translucent moulding trim.

A permanent solution that is simple in design, attractive, weather resistance, inexpensive to manufacture and easy to install.

Other advantages, variations and other features of the invention will become apparent from the drawings, the further description of examples and the claims to follow.

### BRIEF DESCRIPTION OF THE DRAWINGS

FIG. 1A. shows a perspective view of the electronic moulding trim affixed to the exterior of the house.

FIG. 1B. shows a perspective view of the electronic moulding trim affixed to the interior surface of a house along the trim lines;

FIG. 2A. shows a perspective view of incorporating the principles of the present invention.

FIG. 2B. is a side view profile of the electronic moulding trim and mounting bracket not attached to each other.

FIG. 2C. is a side view profile of the electronic moulding trim and mounting bracket attached to each other.

FIG. 3. is the back and inside view of the electronic moulding trim, showing how the electronic moulding trim connect to each other modularly with the attached wire connector on both end of LEDs and shows how it connects to a remote control receiver and showing the wireless remote controller itself.

FIG. 4. Shows a perspective view of how the electronic moulding trim and the trim corner block connect to each other along the trim line.

FIG. 5. Shows a perspective view of how the electronic moulding trim and the trim corner block connect to each other around doors and windows.

### DETAILED DESCRIPTION AND BEST MODE OF IMPLEMENTATION

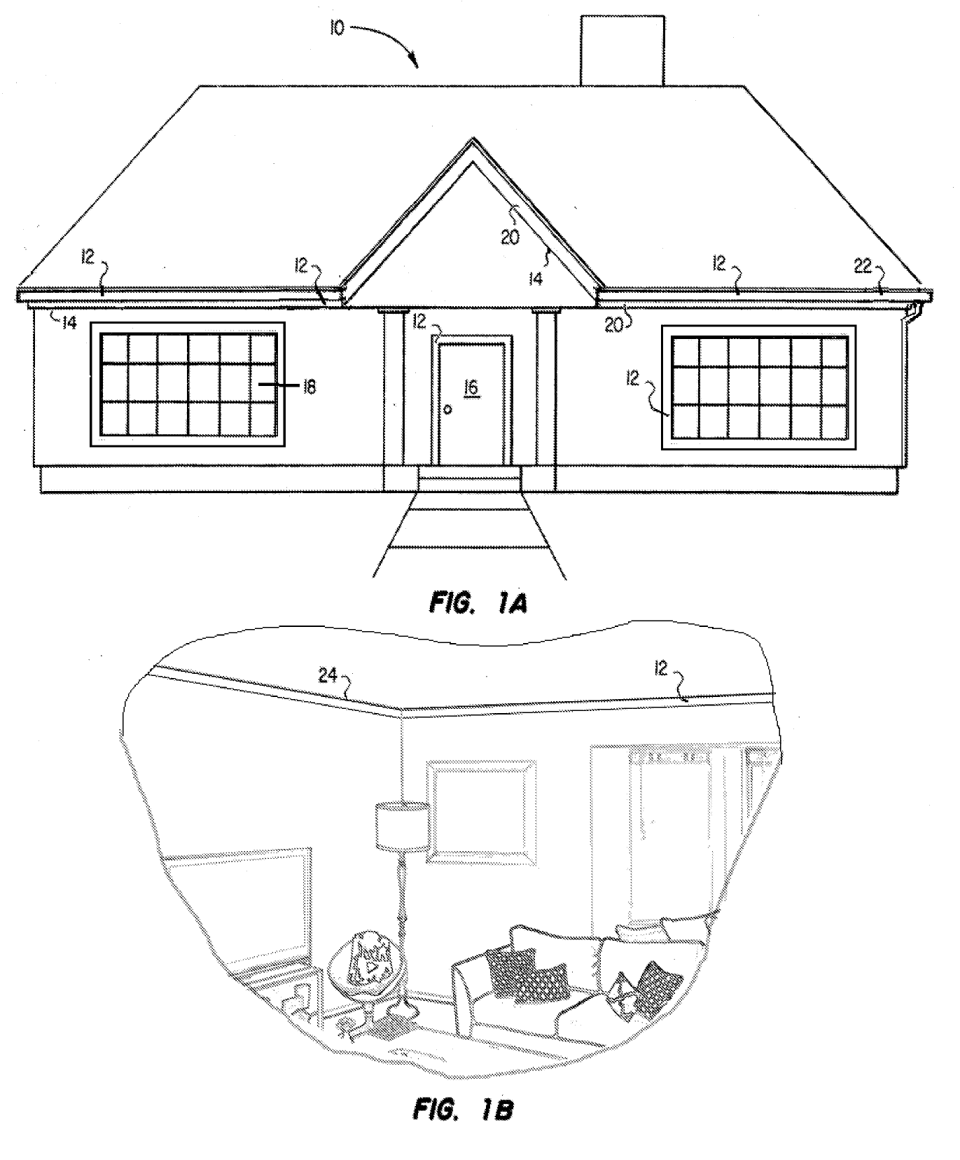

Referring now to the figures and particularly to FIG. 1A there is illustrated therein an electronic moulding trim 12 installed securely to eaves 14 or fascia 20 or gutters 22 of a house 10 and around the doors 16 and windows 18 thereof, and FIG. 1B is the interior along the trim line 24 of the inside of a house 10 of FIG. 1A.

The power source to the electronic moulding trim 12 may be hardwired or pulled directly to the power outlet.

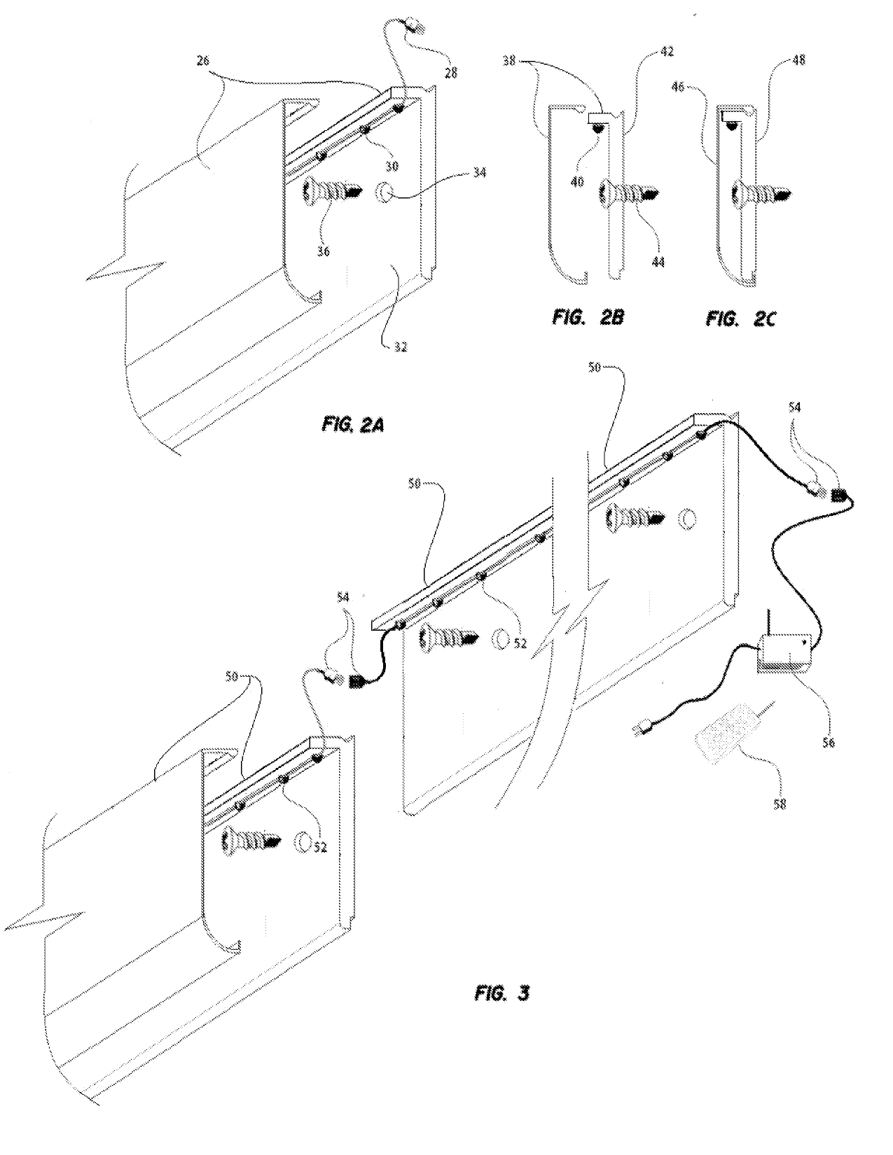

Referring now to FIG. 2A. the present invention, electronic moulding trim 26 is made of weather resistance translucent material in a form of decorative moulding trim with a permanently installed multicolored LED lights or color changing LEDs (light emitting diodes) 30 inside therein with attached wire connector 28 on both ends to connect to another electronic moulding trim modularly. With the included mounting bracket 32 and screw 36, the mounting bracket can be attached to eaves, fascia, gutters and around windows, doors and inside of a house interior along the trim line formed by the ceiling and the wall, using the included screw through the holes 34 of the mounting bracket 32, then the electronic moulding trim decorative front cover 26 snaps in place to the mounting bracket 32.

FIG. 2B is a side view profile of the electronic moulding trim 38 with a permanently installed multicolored LED lights or color changing LEDs (light emitting diodes) 40 inside therein, and the side view profile of a mounting bracket 42 with the illustration of the screw 44 inserted through one of the hole of the mounting bracket 42.

FIG. 2C is the illustration of a side view profile of the electronic moulding trim 46 and the mounting bracket 48 showing how they are attached together.

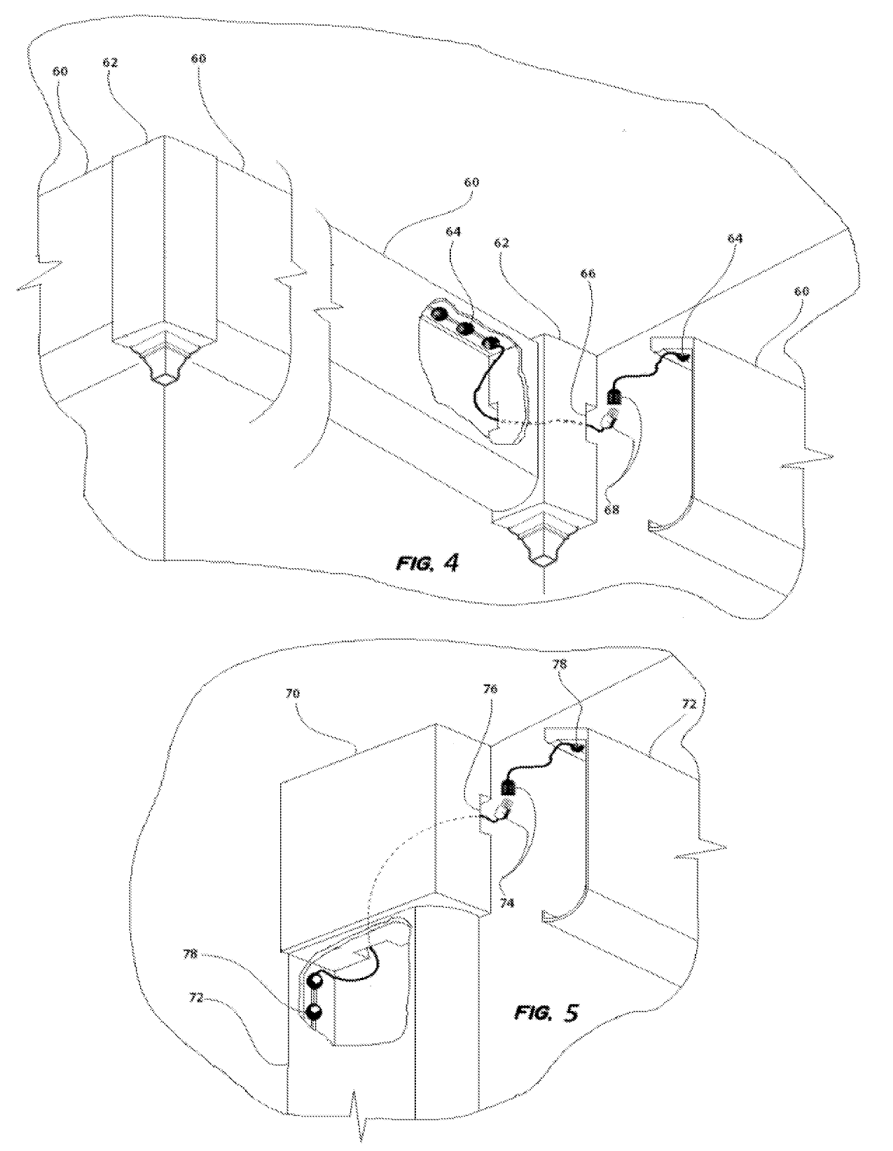

Described in further details in FIG. 3 is the back and inside view of the electronic moulding trim 50 with a better view of plurality of the permanently installed multicolored LED lights or color changing LEDs (light emitting diodes) 52 inside therein, and showing how the electronic moulding trim 50 connect to each other modularly with the attached wire connector 54 on both end of the LED 52, and shows how it connects to a remote control receiver 56 and showing the wireless remote controller itself 58.

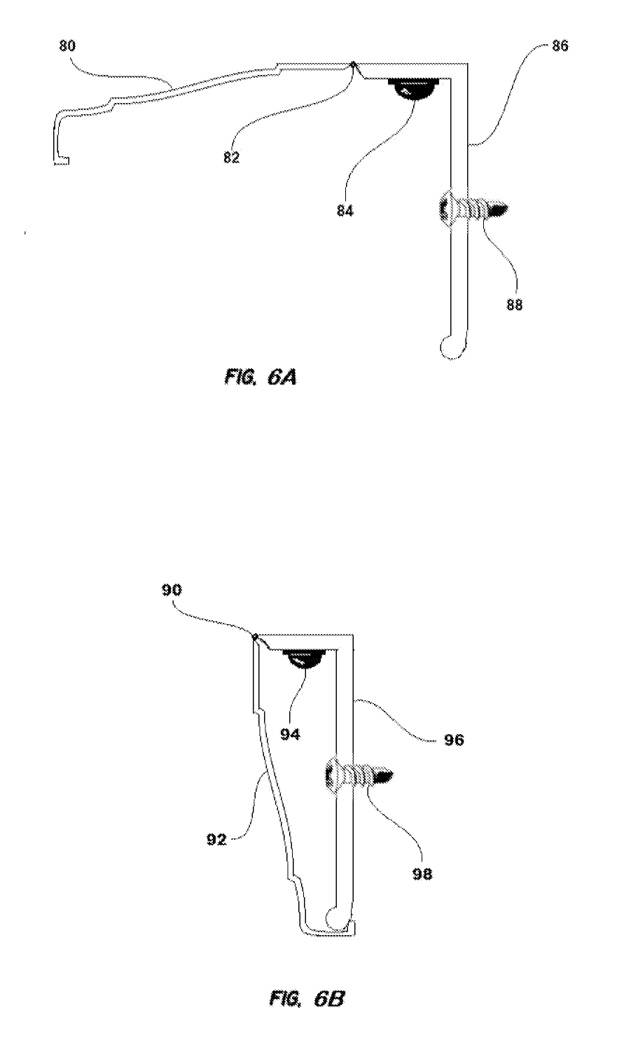

FIG. 4. Shows a perspective view of the electronic moulding trim 60, showing how they interconnect together on corners with the corner block 62, to the trim line of a house, the attached wire connector 68 of the LED 64 feeds through the groove 66 of the corner block 62 to the other side, then connects to the other end of the wire connector 68 attached to the next LED 64 completing the connection.

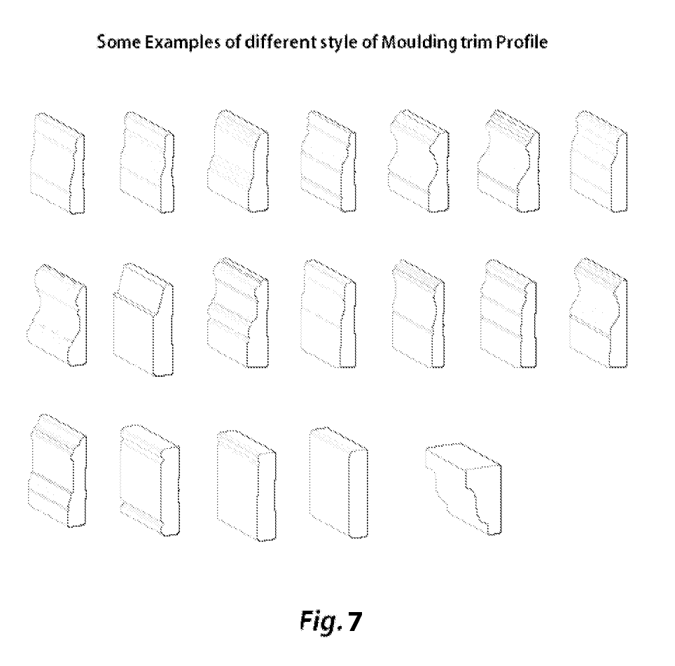

FIG. 5. Shows a perspective view of the electronic moulding trim 72, showing how they interconnect together on corners with the corner block 70, to around doors and windows of a house, the attached wire connector 74 of the LED 78 feeds through the groove 76 of the corner block 70 to the other side, then connects to the other end of the wire connector 74 attached to the next LED 78 completing the connection.

### ALTERNATIVE EMBODIMENTS

Referring now to the drawing FIG. 6A illustrate a side view profile of the Electronic moulding trim in an open position with a permanently installed LEDs 84 inside therein and the illustration of a screw 88 inserted through one of the hole of the mounting bracket 86. The electronic moulding trim decorative front cover 80 and mounting bracket 86 may be permanently attached to each other by hinges or by living hinges 82 to open or closed for installation or repair purposes only. And drawing FIG. 6B illustrate a side view profile of the Electronic moulding trim in a closed position with a permanently installed LEDs 94 inside therein and the illustration of a screw 98 inserted through one of the hole of the mounting bracket 96. The electronic moulding trim decorative front cover 92 and mounting bracket 96 may be permanently attached to each other by hinges or by living hinges 90 to open or closed for installation or repair purposes only.

Profile of electronic moulding trim may be different style. For some example see FIG. 7

LEDs may be position anywhere inside the electronic moulding trim and may add lens or reflective material to enhance the brightness of the illumination of the light.

LEDs may be replaced with other kinds of lights e.g. multi colored incandescent bulb as long as it fits inside the electronic moulding trim.

Electronic moulding trim may be controlled with or without the use of a remote control device.

Although the invention has been described in detail in connection with the exemplary embodiments, it should be understood that the invention is not limited to the above disclosed embodiments. Rather, the invention can be modified to incorporate any number of variations, alternations, substitutions, or equivalent arrangements not heretofore described, but which are commensurate with the spirit and scope of the invention.

Accordingly, the invention is not limited by the foregoing description or drawings, but is only limited by the scope of the appended claims.

1. An electronic moulding trim system comprising: a plurality of translucent housing each forming an interconnecting enclosed modular compartment with a plurality of integrated multicolored LED lights or color changing LEDs (light emitting diodes), having at least one elongate base track mountable to a support surface;
an affixment means disposed on a first free end of each of said housings, the affixment means for separably joining to a second free end of an adjacent housing, the affixment means having exterior surfaces extending parallel to and contiguous with the exterior surfaces of the housings;
an electrical coupling means for electrically coupling the plurality of LEDs when the plurality of housings are joined, wherein a portion of the electrical coupling means is disposed secured to and housed within the affixment means, the remaining portions of the electrical coupling means located on said second free end of the adjacent housing being disposed within the affixment means when the housing is joined to the adjacent housing;
a power coupling means for coupling a power source to the LEDs, the power coupling means having a power coupling housing; and
a controlling device.

2. The electronic moulding trim system of claim 1 further comprising at least one decorative element disposed over the cover, the decorative element including decorative features.

3. The electronic moulding trim system device of claim 1, wherein the electrical coupling means comprises a plurality of electrical wires, one of the plurality of electrical wires fixedly secured to each of the first free ends of the housings, and a plurality of electrical sockets, one of the plurality of electrical sockets fixedly mounted on each of the second free ends of the housings, the electrical sockets for capturing and removably retaining therein an adjacent electrical plug of an adjacent cojoined housing.

4. The electronic moulding trim system of claim 1, wherein the plurality of LED further comprises at least one LED bulb capable of receiving electric current from an electricity source and emitting light; wherein at least some light emitted by the at least one LED bulb is color changing passing through at least one translucent cover.

5. The electronic moulding trim system of claim 1, wherein the support surface is an architectural building aspect.

6. The electronic moulding trim system of claim 1, wherein the affixment means comprises of a double-sided tape, a fabric hook and loop fastener, a screw, or a mounting bracket.

7. The electronic moulding trim system of claim 1, wherein the moulding trim further comprises of a weather resistant material.

8. The electronic moulding trim system of claim 1, wherein the LED bulb comprises of replaceable bulbs of other kinds e.g. incandescent light bulbs.

9. The electronic moulding trim system of claim 1, wherein the controlling device is a wireless remote control.

10. The electronic moulding trim system of claim 9, further comprising a control means for selectively activating any number of the LED in a desired order, duration, intensity and pattern.

11. A method of assembling an electronic moulding trim system, the method comprising:
a plurality of translucent housing each forming an interconnecting enclosed modular compartment therein with a plurality of integrated multicolored LED lights or color changing LEDs (light emitting diodes), having at least one elongate base track mountable to a support surface and having at least one surface thereof permitting the transmission of light there through;
an affixment means disposed on a first free end of each of the housings, the affixment means for separably joining to a second free end of an adjacent housing, the affixment means having exterior surfaces extending parallel to and contiguous with the exterior surfaces of the housings;
an electrical coupling means for electrically coupling the plurality of LED when the plurality of housings are joined, wherein a portion of the electrical coupling means is disposed secured to and housed within the affixment means, the remaining portions of the electrical coupling means located on said second free end of the adjacent housing being disposed within the affixment means when the housing is joined to the adjacent housing;
a power coupling means for coupling a power source to the LED, the power coupling means having a power coupling housing; and
a controlling device.

12. The method of assembling an electronic moulding trim system of claim 11, the method further comprising the electrical coupling means comprises a plurality of electrical wires, one of the plurality of electrical wires fixedly secured to each of the first free ends of the housings, and a plurality of electrical sockets, one of the plurality of electrical sockets fixedly mounted on each of the second free ends of the housings, the electrical sockets for capturing and removably retaining therein an adjacent electrical plug of an adjacent cojoined housing.

13. The method of assembling an electronic moulding trim system of claim 11, the method further comprising the plurality of LED further comprises at least one LED bulb capable of receiving electric current from an electricity source and emitting light; wherein at least some light emitted by the at least one LED bulb is color changing passing through at least one translucent cover.

14. An electronic moulding trim system comprising: at least one elongate base track mountable to a support surface, the at least one base track comprising: a light emitting diode (LED) seat;
and parallel attachment grooves; at least one cover, the cover being at least partially translucent and disposed adjacent the base track such that the rails engage with the attachment grooves; and
at least one LED bulb disposed between the cover and the LED seat, and the LED bulb capable of receiving electric current from an electricity source and emitting light; and a controlling device.
